(19) United States
(12) Patent Application Publication
(10) Pub. No.: US 2026/0364693 A1
(43) Pub. Date: Nov. 19, 2026

(54) Thread Milling Cutter

(71) Applicant: Gühring KG, Albstadt (DE)

(72) Inventors: Tim Käppeler, Bingen (DE); Emin Necetin, Sigmaringen (DE)

(73) Assignee: Gühring KG, Albstadt (DE)

(21) Appl. No.: 19/677,284

(22) Filed: May 14, 2026

(30) Foreign Application Priority Data
May 16, 2025 (DE) DE102025119036.4

(51) Int. Cl. B23G 5/18

(52) U.S. Cl. CPC B23G 5/18; B23G 2240/12

(57) ABSTRACT

A thread milling cutter (1; 100; 200) with a shaft (2) and a cutting part (4) is provided, which has several cutting webs (8) separated from one another in the circumferential direction by means of chip flutes (6) and each with a plurality of cutting teeth (10). At least one cutting web (8) has at least one flute (14), which runs along the cutting web (8) and which divides the cutting teeth (10) into tooth sections (16, 18, 20, 22).

### BACKGROUND AND SUMMARY OF THE INVENTION

The invention relates to a thread milling cutter with a shaft and a cutting part, which has several cutting webs separated from one another in the circumferential direction by means of chip flutes and each with a plurality of cutting teeth.

With regard to process reliability and thread quality, thread milling is the leading method for the thread production. The thread milling is suitable for the production of internal and external threads and can be used by a wide variety of materials and including high-strength materials. The thread is created by means of a spiral ramping of the rotating thread milling cutter. The lateral movement of the thread milling cutter thereby creates the pitch of the thread in one rotation. The prerequisite for this is a CNC machine with at least three axes, in the case of which the movement along the X and Y axis determines the diameter of the thread to be created, while the movement along the Z axis defines the pitch of the thread.

Thread milling cutters for thread milling are known in a variety of ways from the prior art. They usually have a shaft for clamping into a machine tool as well as a cutting part. The cutting part has cutting bars or cutting webs, which are separated by means of chip flutes running in a straight line or spirally with a plurality of cutting teeth arranged axially one behind the other for creating the thread.

The thread cutting tool shown in the publication EP 1 314 506 B1 (incorporated herein by reference), which can be used as thread milling cutter, has a cylindrical shaft and a cutting edge part with several cutting bars separated from one another by means of chip flutes running in a straight line. The cutting bars have a plurality of spirally arranged cutting teeth, which have cutting edges leading in the direction of rotation of the tool and a back trailing the cutting edges. The cutting teeth each have a free space. On the free spaces downstream from the respective cutting edges, at least a portion of the cutting teeth has an undercut, which is to reduce the wear of the tool and are to provide for longer service lives of the tool because the cutting edges of the cutting teeth have less damage and fewer fractures even after longer use.

A further generic thread milling cutter is known from the publication WO 2009/037094 A1, incorporated herein by reference. The thread milling cutter has a shaft and a cutting part with three cutting bars, which are separated from one another by means of chip flutes and which each have several cutting teeth arranged axially one behind the other, wherein analogous cutting teeth of different cutting bars each have the same axial position. The chip flutes as well as the cutting bars are positioned slightly at an angle with respect to the axis of rotation of the thread milling cutter. At least the cutting part of the thread milling cutter consists of a specific solid hard material in order to improve the wear resistance and to lower the susceptibility to breakage in particular during the processing of very hard materials and very small thread diameters.

In the case of thread milling cutters of the above-mentioned type, forces occurring during the processing process can, in combination with the natural frequencies of the tool, lead to vibrations and high stresses of the cutting teeth or of the tool, respectively. The process-related vibrations can occur between the workpiece and the thread milling cutter and are also referred to as rattling. Vibrations cannot only have a negative impact on the service life of the thread milling cutter but also on the quality of the thread to be created. The occurrence of vibrations during the processing process is a function, for example, on the selection of the chip sizes, such as chip thickness, chip width and cutting speed. An improper lubrication can also increase the friction between the workpiece and the thread milling cutter and can lead to unwanted vibrations.

With regard to the structure of thread milling cutters, it is known to form the cutting bars with a dissimilar division around the tool axis of rotation in order to reduce vibrations. However, there is a further need for developing thread milling cutters, which avoid or prevent vibrations, respectively, during the thread milling process and thus have a longer service life.

Based on the thread milling cutter known from the EP 1 314 506 B1 (incorporated herein by reference), the present invention provides a thread milling cutter, in the case of which vibrations can be reduced or prevented, respectively, and the service life can be increased during the thread production process.

This objective is solved, for example, by means of a thread milling cutter according to claim 1. The subclaims relate to advantageous designs.

A thread milling cutter has a shaft and a cutting part, which has several cutting bars or cutting webs, respectively, separated from one another in the circumferential direction by means of chip flutes, each with a plurality of cutting teeth. At least one cutting web can have at least one flute, which runs along the cutting web and which divides the cutting teeth into tooth sections.

The thread milling cutter can have a cylindrical shaft for clamping into a machine tool. The cutting part axially adjoining the shaft has several chip flutes, which can run in a straight line along the tool axis of rotation or which can run at an angle with respect to the tool axis of rotation, i.e., spiralized, i.e., have an angle of twist. The cutting webs, which lie between the chip flutes in the circumferential direction and which can also be referred to as cutting bars, each have a plurality of cutting teeth, which lie axially one behind the other.

The several cutting teeth of each cutting web are separated from one another in the axial direction by means of web flutes or tooth gaps, respectively. Each cutting tooth can have, leading in the direction of rotation of the thread milling cutter, two preferably identical secondary cutting edges, which form tooth flank edges and which are aligned at a preferably acute angle to one another and which are connected to one another, preferably via a main cutting edge, which forms the tip or the tooth head, respectively, of the cutting tooth and which can form a radius. The secondary cutting edges intersect with the thread flanks of the thread and the main cutting edge intersects with the thread base and the regions adjoining the thread base. The alignment of the secondary cutting edges as well as the course of the main cutting edge can thus be adapted to the desired thread form of the thread, which is to be produced by means of the thread milling cutter. On its tooth back in the region downstream from the main cutting edge, each cutting tooth can have a free space, which has a clearance angle to the cutting surface created by the main cutting edge. In other words, the height of each cutting tooth can decrease opposite to the circumferential direction/direction of rotation of the thread milling cutter.

At least one cutting web can have at least one flute, which runs along the cutting web and which divides the cutting teeth into tooth sections, which are spaced apart from one another in the circumferential direction/direction of rotation. In the case that exactly one flute is present, the flute can lie centrally or eccentrically in the circumferential direction of the thread milling cutter. In the case of one or several flutes, each flute can preferably run parallel to the chip flute lying in front of the cutting web. Each flute can furthermore extend across the entire length of the cutting web.

The flute running along the cutting web interrupts the course of the tooth back or of the free space, which is present on the tooth back, respectively, and increases the distance of the tooth back or of the free space, respectively, from the cutting surface in the workpiece created by the main cutting edge. In particular in the case of very small clearance angles, the flute can reduce a strong friction between the tooth back and the workpiece, in particular the region of the workpiece, which is processed by the main cutting edge, and can thus minimize vibrations or oscillations of the thread milling cutter. The flute furthermore improves a distribution of cooling lubricant along the cutting web, so that the lubrication as a whole is improved, whereby vibrations can be reduced and the smooth running of the thread milling cutter can be increased. A cooling lubricant cushion can furthermore be formed between the flute and the surface processed by the main cutting edge, which cooling lubricant cushion can contribute to minimizing vibrations of the thread milling cutter. With the flute, the thread milling cutter as a whole is more durable and has a longer service life.

The at least one cutting web can have several flutes running parallel to one another.

The effect of the reduction of vibrations or oscillations can be further intensified by means of the formation of several flutes on the at least one cutting web. The several flutes running parallel can be formed easily on the at least one cutting web, e.g., by means of a grinding method and a grinding disk.

The tooth sections of each cutting tooth can have the same widths measured in the circumferential direction.

When the tooth sections of each cutting tooth have the same widths measured in the circumferential direction, in particular along the tooth back, the flutes are distributed evenly, whereby cooling lubricant can be distributed evenly across the entire width of the cutting tooth measured in the circumferential direction. An optimal lubrication results, whereby vibrations can be reduced and the smooth running of the thread milling cutter can be increased. One or several cooling lubricant cushions, which can counteract the creation of vibrations, can furthermore form between the flutes and the surface processed by the main cutting edge.

However, the tooth sections of each cutting tooth, measured in the circumferential direction, can alternatively also have different widths.

Due to the different widths of the tooth sections, measured in the circumferential direction, in particular along the tooth back, the cutting tooth has an irregular division. This irregular division effects a reduction of the occurrence of vibrations, in a similar way as the irregular division of the cutting bars or cutting webs, respectively, in the circumferential direction of the thread milling cutter. As a whole, the stability of the cutting teeth and the service life of the thread milling cutter can be increased.

Independently of whether the tooth sections of each cutting tooth have the same or different widths measured in the circumferential direction, in particular along the tooth back, the at least one cutting web with the at least one flute running along the cutting web can have a width measured in the circumferential direction, which is greater than the widths of the cutting webs without flute measured in the circumferential direction. In terms of a reduction of vibrations and oscillations of the thread milling cutter, the width of the cutting web with the at least one flute measured in the circumferential direction is preferably greater by the amount of the flute width measured in the circumferential direction (in the case that the cutting web has exactly one flute) or the total amount of the flute widths measured in the circumferential direction (in the case that the cutting web has several flutes) than the width of a cutting web without flute measured in the circumferential direction.

In the alternative, the widths of all cutting webs measured in the circumferential direction can be of the same size.

The at least one flute can have a radial depth, which is maximally 10% of the depth of a chip flute.

The chips removed from the main cutting edge and the secondary cutting edges of the cutting teeth are discharged via the chip flute. A radial depth of the flute of maximally 10% of the depth of a chip flute can avoid that chips get stuck in the flute and thus negatively impact the thread milling process, for example by means of a deteriorated cooling lubricant distribution or that the surface quality of the created thread is reduced by means of chips stuck in the flute.

The at least one flute can have a radial depth, which is maximally 10% of the height of a cutting tooth.

The stability of the cutting tooth is not negatively impacted in the case of a radial depth of the at least one flute, which is maximally 10% of the height of a cutting tooth. At the same time, the depth of the at least one flute is large enough to reduce or avoid, respectively, vibrations and oscillations of the thread milling cutter and to increase the service life of the thread milling cutter. The cutting tooth height can be the length measured perpendicularly from a web flute to an apex of the main cutting edge of the cutting tooth.

The at least one flute can have a semi-circular cross section.

When chips or chip parts, respectively, reach into the region of the tooth back of the cutting tooth, the semi-circular cross section of the at least one flute can help prevent that the chips or chip parts get stuck and simplify a flush-out by means of cooling lubricant.

The at least one flute can axially taper at the same height with the chip flutes.

It can be ensured in this way that all cutting teeth of a cutting web are divided into tooth sections in the direction of rotation or circumferential direction, respectively, by means of at least one flute. The production of the thread milling cutter can furthermore be simplified.

The cutting webs can be arranged around the thread milling cutter axis with dissimilar angular division.

It is sufficient when the cutting webs are arranged with dissimilar angular division around the thread milling cutter axis at at least one position along the cutting part. On a front end of the cutting part facing away from the shaft, the cutting webs can in particular have a dissimilar angular division, i.e., dissimilar angular distances between the cutting webs. In the alternative, the dissimilar angular division of the cutting webs can be present on a shaft-side rear end or at a position within the cutting part, for example in the longitudinal center of the cutting part. It is also possible that the cutting webs are arranged with dissimilar angular division around the thread milling cutter axis at several positions along the cutting part or via an axial longitudinal section along the cutting part.

A dissimilar angular division of the cutting webs can be achieved in that the angular pitch between two cutting webs adjacent to one another in the circumferential direction differs from the pitch angle between two further cutting webs adjacent to one another in the circumferential direction. The angle between a leading end in the circumferential direction of rotation of a first cutting web and a leading end in the circumferential direction of rotation of a second cutting web adjacent to the first cutting web is understood to be the pitch angle. The dissimilar angular division can effectively reduce a creation of vibrations or oscillations, which additionally leads to a more stable thread milling process and contributes to a high-quality thread surface.

The cutting part can be formed in a straight-fluted manner, wherein the cutting webs have a spiral angle or angle of twist, respectively, of 0°, wherein the production of the cutting part is simplified.

Alternatively, the cutting part can be formed in a helically or spirally fluted manner, respectively, wherein the cutting webs have a spiral angle or angle of twist, respectively, of greater than 0°. The cutting webs can thus wind around the tool axis of rotation of the thread milling cutter.

In the latter case, the above-mentioned dissimilar angular division of the cutting webs can also be achieved in that the cutting webs have dissimilar spiral angles or angles of twist, respectively.

When a cutting web has a constant width measured in the circumferential direction across the entire axial length of the cutting part, the angle of twist of the chip flute leading the cutting web as well as the angle of twist of the chip flute trailing the cutting web corresponds to an angle of twist of the cutting web lying between the chip flutes. In the case of a right-turning thread milling cutter, the chip flutes can in particular have a positive angle of twist (in a front view of the thread milling cutter, the chip flutes twist clockwise around the tool axis of rotation), so that chips generated during the thread milling process are conveyed in the direction of the shaft. In the case of a left-turning thread milling cutter, the chip flutes can analogously have a negative angle of twist (in a front view of the thread milling cutter, the chip flutes twist counter-clockwise around the tool axis of rotation), so that chips generated during the thread milling process are conveyed in the direction of the shaft.

On a front end of the cutting part facing away from the shaft, the cutting webs can, for example, have a dissimilar angular division, wherein all chip flutes or all cutting webs, respectively, have the same angle of twist of greater than 0°. A dissimilar angular division of the cutting webs around the thread milling cutter axis is thus achieved across the entire axial length of the cutting part.

The angle of twist of at least two chip flutes can differ.

The angle of twist of the cutting web with the at least one flute running along the cutting web can in particular differ from the angle of twist of a further cutting web.

When the angles of twist of at least two cutting webs differ, it can be achieved that the cutting webs are arranged with dissimilar angular division around the thread milling cutter axis at least at a position along the cutting part or at least in an axial longitudinal region within the cutting part, for example in the longitudinal center of the cutting part.

The wording “at least one cutting web has at least one flute running along the cutting web” also includes that exactly one cutting web has at least one flute, which runs along the cutting web and which divides the cutting teeth of the cutting web into tooth sections and that several cutting webs or all cutting webs have at least one flute, which runs along the respective cutting webs and which divides the cutting teeth of the respective cutting webs into tooth sections.

When each cutting web has at least one flute, which runs along the cutting web and which divides the cutting teeth into tooth sections, vibrations and oscillations of the thread milling cutter can be avoided particularly well. The distribution of cooling lubricant around the entire circumference of the thread milling cutter is furthermore improved.

The thread milling cutter can have an internal cooling lubricant channel, which preferably runs on the tool axis of rotation.

Cooling lubricant can be transported in a simple way to the front-side front end of the thread milling cutter facing away from the shaft and the cutting teeth lying on this end of the thread milling cutter through the internal cooling lubricant channel. The cooling lubricant can then be guided to all cutting teeth of the cutting web via the at least one flute, which runs along the at least one cutting web, so that a good lubrication and cooling of the thread milling cutter is achieved. Alternatively to the internal cooling lubricant channel, a supply with cooling lubricant is also possible from an outer circumferential side of the thread milling cutter.

### BRIEF DESCRIPTION OF DRAWINGS

Further details, features and advantages result from the following description of embodiments and on the basis of the drawings, in which:

FIG. 1a shows a thread milling cutter according to an embodiment in a side view;

FIG. 1b shows a front view of the thread milling cutter from FIG. 1a;

FIG. 1c shows a detail view of the region A from FIG. 1b;

FIG. 2a shows a thread milling cutter according to a second embodiment in a side view;

FIG. 2b shows a front view of the thread milling cutter from FIG. 2a;

FIG. 2c shows a detail view of the region A from FIG. 2b;

FIG. 3a shows a thread milling cutter according to a third embodiment in a side view;

FIG. 3b shows a front view of the thread milling cutter from FIG. 3a; and

FIG. 3c shows a detail view of the region A from FIG. 3b.

### DETAILED DESCRIPTION OF THE INVENTION

### First Embodiment

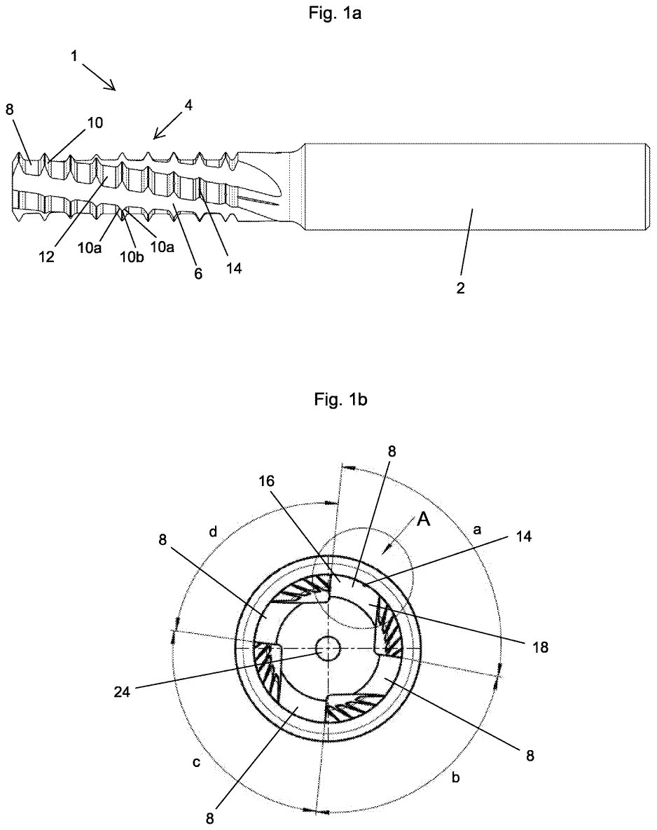

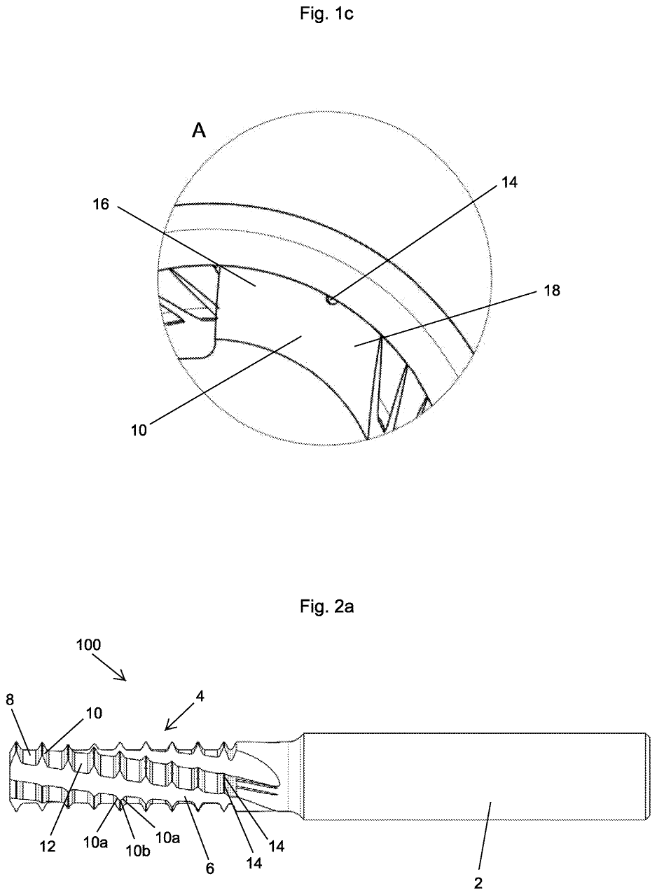

FIG. 1a shows a right-turning thread milling cutter 1 with a cylindrical shaft 2 for clamping into a machine tool and a cutting part 4. As shown in FIG. 1b, the cutting part 4 has four cutting webs 8 separated from one another in the circumferential direction by means of chip flutes 6. As illustrated in FIG. 1b by means of the pitch angles a, b, c, d, the cutting webs 8 are arranged with dissimilar angular division around the thread milling cutter axis.

Each cutting web 8 has a plurality of cutting teeth 10, which lie axially one behind the other and which are separated from one another by means of web flutes 12. Leading in the direction of rotation of the thread milling cutter 1, each cutting tooth 10 has two secondary cutting edges 10a, which are aligned at an acute angle to one another and which are connected to one another via a main cutting edge 10b, which forms the tip of the cutting tooth 10 and which forms a radius. The secondary cutting edges 10a intersect with the thread flanks of the thread and the main cutting edge 10b intersects with the thread base and the regions adjoining the thread base.

The cutting webs 8 run at a positive angle of twist of greater than 0° around the tool axis of rotation, i.e., the cutting webs 8 wind clockwise around the tool axis of rotation in a front view of the thread milling cutter 1. Removed chips are transported in the direction of the shaft 2 during the thread milling process by means of the chip flutes 6, which likewise run at a positive angle of twist of greater than 0° around the tool axis of rotation.

One of the four cutting webs 8, which is illustrated in a detail view A in FIG. 1c, has a flute 14, which divides each cutting tooth 10 of the cutting web 8 into a first tooth section 16 and a second tooth section 18. The first tooth section 16 and the second tooth section 18 have different lengths measured in the circumferential direction. The flute 14 axially tapers at the same height with the chip flutes 6. As shown in FIG. 1c, the flute 14 has a semi-circular cross section. The flute 14 furthermore has a radial depth, which is maximally 10% of the depth of a chip flute 6 and maximally 10% of the height of a cutting tooth 10.

Each of the four cutting webs 8 has a width measured in the circumferential direction, which in each case remains the same across the entire axial length of the cutting part 4. The cutting web 8 with the flute 14 running along the cutting web 8 furthermore has a width measured in the circumferential direction, which is greater than the widths of the cutting webs 8 without flute 14 measured in the circumferential direction. In terms of a reduction of vibrations and oscillations of the thread milling cutter 1, the width of the cutting web 8 with the at least one flute 14 measured in the circumferential direction is greater by the amount of the width of the flute 14 measured in the circumferential direction than the width of a cutting web 8 without flute 14 measured in the circumferential direction.

The flute 14 running along the cutting web 8 interrupts the course of the tooth back and increases the distance of the tooth back from the circumferential surface created by the main cutting edge 10b or from the thread surface created by the main cutting edge 10b, respectively. The flute 14 can reduce a strong friction between the tooth back and the workpiece, in particular the region of the workpiece processed by the main cutting edge 10b and can thus minimize vibrations or oscillations of the thread milling cutter 1. The flute 14 furthermore improves a distribution of cooling lubricant along the cutting web 8, so that the lubrication as a whole is improved, whereby vibrations can be reduced and the smooth running of the thread milling cutter 1 can be increased. FIG. 1b shows the opening of a cooling lubricant channel 24, which runs in the thread milling cutter 1 on the tool axis of rotation and via which cooling lubricant is guided to the front side of the thread milling cutter 1. A cooling lubricant cushion, which can contribute to minimizing vibrations of the thread milling cutter 1, can furthermore be formed between the flute 14 and the thread surface processed by the main cutting edge 10b. As a whole, the thread milling cutter 1 is durable due to the flute 14 and has a long service life.

### Second Embodiment

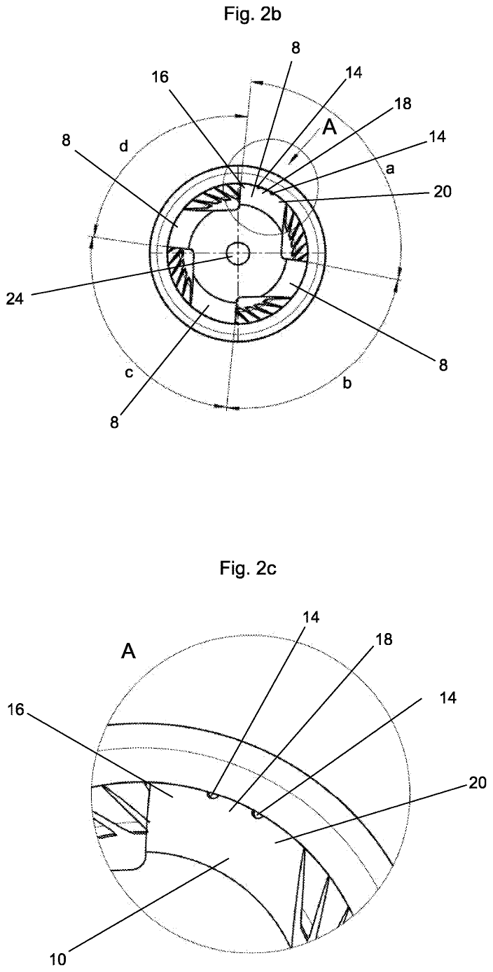

FIG. 2a shows a right-turning thread milling cutter 100 with a cylindrical shaft 2 for clamping into a machine tool and a cutting part 4. Features, which correspond to the thread milling cutter 1 of the first embodiment, are identified with the same reference numerals in FIGS. 2a to 2c. Only differences compared to the first embodiment will thus be discussed below.

In contrast to the first embodiment, the thread milling cutter 100 of the second embodiment has two flutes 14 running parallel to one another on one of its four cutting webs 8, which are separated from one another in the circumferential direction by means of chip flutes 6. As shown in particular in FIGS. 2b and 2c, the flutes 14 divide the cutting teeth 10 into a first tooth section 16, a second tooth section 18 and a third tooth section 20. The tooth sections 16 and 20 have the same length measured in the circumferential direction, while the second tooth section 18 is shorter measured in the circumferential direction.

Each of the four cutting webs 8 has a width measured in the circumferential direction, which in each case remains the same across the entire axial length of the cutting part 4. The cutting web 8 with the two flutes 14 running along the cutting web 8 furthermore has a width measured in the circumferential direction, which is greater than the widths of the cutting webs 8 without flute 14 measured in the circumferential direction. In terms of a reduction of vibrations and oscillations of the thread milling cutter 100, the width of the cutting web 8 with the two flutes 14 measured in the circumferential direction is greater by the total amount of the widths of the flutes 14 measured in the circumferential direction than the width of a cutting web 8 without flute 14 measured in the circumferential direction.

### Third Embodiment

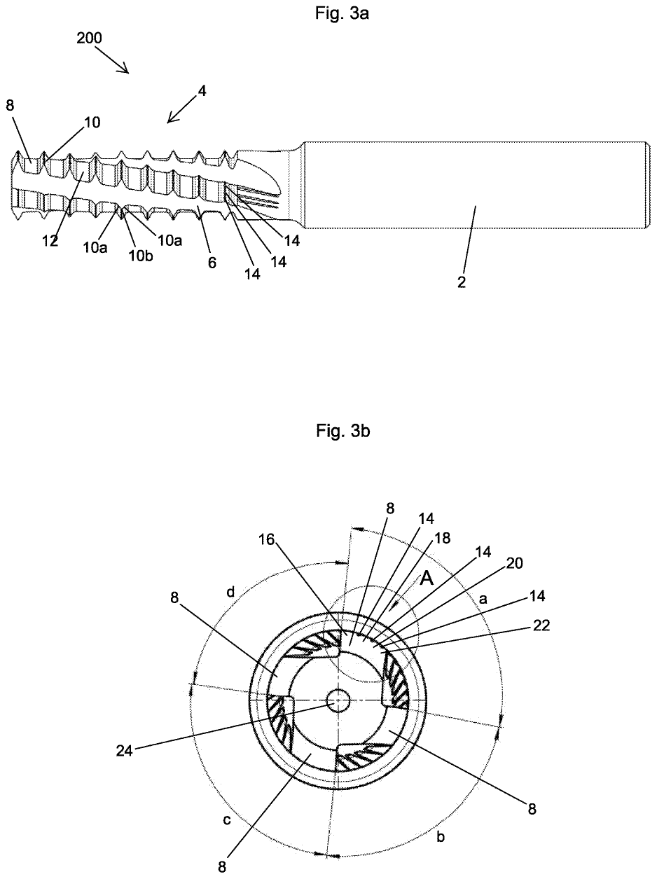

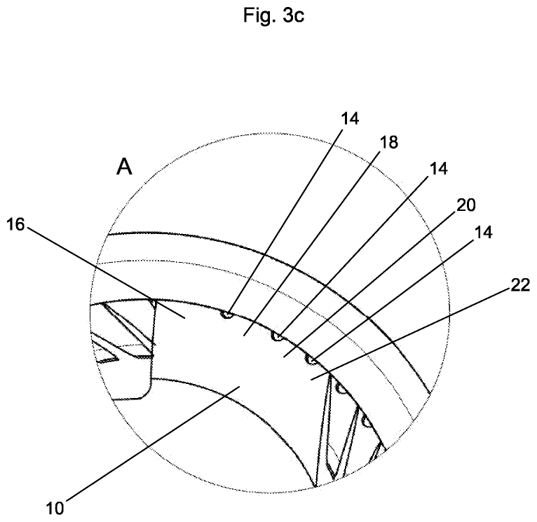

FIG. 3a shows a right-turning thread milling cutter 200 with a cylindrical shaft 2 for clamping into a machine tool and a cutting part 4. Features, which correspond to the thread milling cutter 1 of the first embodiment, are identified with the same reference numerals in FIGS. 3a to 3c. Only differences compared to the first embodiment will thus be discussed below.

In contrast to the first embodiment, the thread milling cutter 200 of the third embodiment has three flutes 14 running parallel to one another on one of its four cutting webs 8, which are separated from one another in the circumferential direction by means of chip flutes 6. As shown in particular in FIGS. 3b and 3c, the flutes 14 divide the cutting teeth 10 into a first tooth section 16, a second tooth section 18, a third tooth section 20 and a fourth tooth section 22. The tooth sections 16, 18, 20 and 22 have different lengths measured in the circumferential direction, wherein the second tooth section 18 is shorter than the first tooth section 16, the third tooth section 20 is shorter than the second tooth section 18, and the fourth tooth section 22 is shorter than the third tooth section 20.

Each of the four cutting webs 8 has a width measured in the circumferential direction, which in each case remains the same across the entire axial length of the cutting part 4. The cutting web 8 with the three flutes 14 running along the cutting web 8 furthermore has a width measured in the circumferential direction, which is greater than the widths of the cutting webs 8 without flute 14 measured in the circumferential direction. In terms of a reduction of vibrations and oscillations of the thread milling cutter 200, the width of the cutting web 8 with the three flutes 14 measured in the circumferential direction is greater by the total amount of the widths of the flutes 14 measured in the circumferential direction than the width of a cutting web 8 without flute 14 measured in the circumferential direction.

### General Remarks

In all of the above-described embodiments, only one of the four cutting webs 8 separated in the circumferential direction by means of chip flutes 6 in each case has a flute 14 or two or three flutes 14, which divides/divide the cutting teeth 10 into tooth sections. In each embodiment, each of the four cutting webs 8 separated in the circumferential direction by means of chip flutes 6 can alternatively have a flute 14 or several, for example two or three, flutes 14, which divides/divide the cutting teeth 10 into tooth sections.

The two or several tooth sections formed by the flute 14 or the flutes 14 can have the same or dissimilar lengths measured in the circumferential direction. In the case of several flutes 14, the lengths of the tooth sections measured in the circumferential direction, i.e., the distance between the flutes, can becomes smaller opposite to the tool direction of rotation.

### LIST OF REFERENCE NUMERALS

a, b, c, d pitch angles
1 thread milling cutter
2 shaft
4 cutting part
6 chip flute
8 cutting web
10 cutting tooth
10a secondary cutting edge
10b main cutting edge
12 web flute
14 flute
16 first tooth section
18 second tooth section
20 third tooth section
22 fourth tooth section
24 cooling lubricant channel

1. A thread milling cutter comprising a shaft and a cutting part, the cutting part having a plurality of cutting webs separated from one another in a circumferential direction by chip flutes and each cutting web having a plurality of cutting teeth, wherein at least one cutting web has at least one flute that runs along the cutting web and divides the cutting teeth into tooth sections.

2. The thread milling cutter of claim 1, wherein the at least one cutting web has a plurality of flutes running parallel to one another.

3. The thread milling cutter of claim 1, wherein the tooth sections of each cutting tooth have the same lengths measured in the circumferential direction.

4. The thread milling cutter of claim 1, wherein the tooth sections of each cutting tooth have different lengths measured in the circumferential direction.

5. The thread milling cutter of claim 1, wherein the at least one flute has a radial depth that is at most ten percent of a depth of one of the chip flutes.

6. The thread milling cutter of claim 1, wherein the at least one flute has a radial depth that is at most ten percent of a height of one of the cutting teeth.

7. The thread milling cutter of claim 1, wherein the at least one flute has a semi-circular cross section.

8. The thread milling cutter of claim 1, wherein the at least one flute axially tapers at a same height as the chip flutes.

9. The thread milling cutter of claim 1, wherein the cutting webs are arranged with dissimilar angular division around an axis of the thread milling cutter.

10. The thread milling cutter of claim 1, wherein the cutting webs have an angle of twist greater than zero degrees.

11. The thread milling cutter of claim 10, wherein angles of twist of at least two of the cutting webs are different from one another.

12. The thread milling cutter of claim 1, wherein each cutting web has at least one flute that runs along the cutting web and divides the cutting teeth into tooth sections.

13. The thread milling cutter of claim 1, further comprising an internal cooling lubricant channel that runs on an axis of rotation of the thread milling cutter.
